(19) United States
(12) Patent Application Publication
(10) Pub. No.: US 2009/0051499 A1
(43) Pub. Date: Feb. 26, 2009

(54) RFID System, Reader, Control, Program and Transmission Method

(75) Inventor: Toshiyasu Nakao, Tokyo (JP)

Correspondence Address: FOLEY AND LARDNER LLP;SUITE 500, 3000 K STREET NW, WASHINGTON, DC, 20007, US

(73) Assignee: NEC corporation

(21) Appl. No.: 11/918,005

(22) PCT Filed: Apr. 6, 2006
(86) PCT No.: PCT/JP2006/307379

§ 371 Date: Oct. 5, 2007

(30) Foreign Application Priority Data
Apr. 7, 2005 (JP) 2005-110459
Aug. 23, 2005 (JP) 2005-241886

(51) Int. Cl. H04Q 5/22

(52) U.S. Cl. 340/10.34

(57) ABSTRACT

A reader (100-1) transmits an interrogation wave to an RFID tag (200) through an antenna (102-1). A reader (100-2) transmits a power supply wave to the RFID tag (200) through an antenna (102-2). The waves to be transmitted in prescribed timing are switched, and the reader (100-1) transmits the power supply wave to the RFID tag (200) through the antenna (102-1). The reader (100-2) transmits the interrogation wave to the RFID tag (200) through the antenna (102-2).

### APPLICABLE FIELD IN THE INDUSTRY

The present invention relates to an RFID system, and more particularly to a technology of an RFID system for transmitting an interrogation wave and a power supply wave to an RFID tag by employing a plurality of antennas, which enables an RFID tag to be detected at a high precision by replacing each of a role of an antenna for transmitting the interrogation wave and a role of an antenna for transmitting the power supply wave with other.

### BACKGROUND ART

In an RFID (Radio Frequency Identification) system that is configured of a device for holding an inherent identifier (ID) and a device for reading off it remotely through a radio wave, the system of reading off data of the RFID tag by transmitting a power and a read command to an ID holding device (RFID tag) from a reading device (reader) is called a passive-type RFID system.

FIG. 1 illustrates an example of a general configuration of such an RFID system, and an example of an interrogation wave/a response wave that are exchanged between the reader/the RFID tag, respectively.

In the upper side of FIG. 1, the reader generates an interrogation wave to the RFID tag with encoding/modulation according to a control command from a PC, and transmits it to the RFID tag through an antenna. The interrogation wave is configured of a carrier wave (power supply wave) for playing a role of supplying a power source to the RFID tag, and a modulated portion of the command to the RFID tag. The carrier wave continues to be transmitted for a purpose of supplying the power to the RFID tag even after the command transmission is finished. The RFID tag picks up the power from the carrier wave, and transmits the ID filed in a memory of the RFID tag as a response wave for aiming at expressing an acceptance of the command of the interrogation wave. Upon receipt of the response wave, the reader demodulates/decodes it, thereby to pick up the ID, and delivers it the PC. Such a configuration of the RFID system, which is widely known, is described in details, for example, in Non-patent document 1, etc.

The reader simultaneously carries out the transmission of the interrogation wave and the reception of the response wave, and yet the power of the response wave is as large as only one-several tenth of that of the interrogation wave. For this, the problems that the detection precision of the RFID tag declines due to influences such as an antenna directivity of the RFID tag and the reader, a change in an antenna characteristic caused by matter to which the RFID tag is attached, radio wave interference from the reader or a personal computer that exists in the circumference occurs.

So as to solve this problem, the technique of employing a plurality of the antennas and a plurality of the readers is described in Patent document 1, Patent document 2, Patent document 3, Patent document 4, and Patent document 5.

The system of Patent document 1 includes one transmitting antenna for transmitting a radio signal to the RFID tag connected to an RFID tag transmitting and receiving circuit, a plurality of receiving antennas for receiving the radio signal being coded and being returned from the RFID tag, each of which has been connected to the RFID tag transmitting and receiving circuit, and a decoding circuit for decoding the data returned from the RFID tag by using a plurality of pieces of encoded data received through a plurality of the receiving antennas, and the technique of decoding a signal of the RFID tag from a plurality of pieces of the encoded data received through a plurality of the receiving antennas is described in Patent document 1. This technology, in which the decoding process is realized by using a plurality of pieces of the encoded data received through a plurality of the receiving antennas, is a technology for eliminating a necessity for the receiving level detection circuit, and preventing the detection precision from declining.

In Patent document 2, the technique is described of causing a plurality of the receiving antennas to work synchronously with each other so that the detection areas thereof do not overlap with each other, thereby to avoid a decline in the detection precision due to interference. That is, the system of Patent document 2 is characterized in that the sales method having a customer identification function adopting a radio frequency includes a step of generating electromagnetic fields each having a predetermined operational range adjacent to respective dispensers in plural and independently, and a step of generating a plurality of electromagnetic fields that are synchronized so that each electromagnetic field corresponds to one side of one dispenser, yet a plurality of the electromagnetic fields do not overlap with the first electromagnetic field in terms of the operational range, respectively, and yet a plurality of the electromagnetic fields furthermore do not overlap with the electromagnetic field in the first side of the first dispenser, and the electromagnetic field in the second side of the second dispenser that corresponds to the first side of the first dispenser, respectively

In Patent document 3, a transmission system is described for adjusting and outputting a phase of a signal of the common oscillation source, thereby to optimize the power supply to the RFID tag. This system is characterized in: including an oscillating means for generating a common reference signal that becomes a reference for generating a carrier wave, a plurality of transmitting means for, from an antenna, emitting an output arranged based upon the carrier wave with an identical frequency generated from this reference signal, which becomes a transmission wave, and a controlling means for sending a control signal to each transmitting means, thereby to control an operation thereof; that each transmitting means includes a phase adjusting means for receiving the reference signal, shifting the phase thereof, and outputting it, and a sending-out means for, based upon the output of the phase adjusting means and the control signal of the controlling means, supplying the output modulated with the transmission signal to the antenna at the time of making communication, and supplying the output, being only a carrier wave, to the antenna at the time of making no communication; and yet that the phase adjusting means is configured to synchronize the phase of the transmission wave being emitted from the antenna with that of the transmission wave by the other transmitting means.

In Patent document 4, the technique is described of transmitting each of an interrogation wave and a power supply wave from a different antenna, thereby to supply a power to the radio tag (RFID tag). That is, the system of this document, which includes a plurality of the antenna parts, is characterized in being configured to: control each antenna part so that each antenna transmits the first transmission wave of the first frequency band for transmitting a response command and supplying a power to the radio wave tag, and the second transmission wave of the second frequency band for supplying a power to the radio wave tag; supply a power to each radio wave tag by means of the first transmission wave and the second transmission wave; and surely receive a reply transmission wave by each antenna part.

In Patent document 5, the non-contact information recording medium and gate system including two of the antenna for transmitting a power carrier wave (power supply wave) and the antenna for transmitting a data carrier wave (interrogation wave), which is capable of suppressing interference between the power carrier wave and the data carrier wave at a low level, and yet of realizing miniaturization of the antennas, is described. That is, the system of this document is characterized in that in an automatic ticket examination device, a loop-like power transmission antenna is arranged at prescribed intervals from the upper side of a main body and a loop-like data transmission/reception antenna is arranged almost concentrically with the power transmission antenna in the inner side of the power transmission antenna, and yet in the radio card (RFID tag) side as well, the loop-like data transmission/reception antenna is arranged almost concentrically with a loop-like power reception antenna in the inner side of the loop-like power reception antenna.

Further, as a technique for aiming at enhancing the detection precision of the general RFID system, the diversity antenna technique is utilized of selecting and using the best signal from among the signals received by a plurality of the antennas.

Non-patent document 1: “ALL RADIO WAVE IC TAG”, Nikkei Business Publications, Inc., Apr. 20, 2004, pp. 18-31 and pp. 34-42

Patent document 1: JP-P2004-282522A

Patent document 2: JP3481254B

Patent document 3: JP-P2002-077001A

Patent document 4: JP-P2004-294338A

Patent document 5: JP-P1997-073524A

### DISCLOSURE OF THE INVENTION

### Problems To Be Solved By the Invention

The first problem is that there is the case that employment of a plurality of the antennas does not always to lead to an improvement to the detection precision in the RFID system.

The reason is that the conventional RFID system assumes a mode in which data is acquired among from the signals received by a plurality of the antennas by making a reference to the best intensity and decoding result, which is equivalent to simply summing up pieces of data obtained by independently utilizing each antenna. There is the possibility that the RFID tag that cannot be detected by each antenna still exists because no detection precision changes in the read operation employing each antenna.

The second problem is that there is the case that, in simultaneously reading off a plurality of the RFID tags, employment of a plurality of the antennas does not always to lead to an improvement to the detection precision.

The reason is that there is the case that in simultaneously reading off a plurality of the RFID tags, in the conventional RFID system, the power supply wave and interrogation wave with a fixed magnitude or phase are simultaneously transmitted from a plurality of the antennas, whereby the magnitude of the power that the RFID tag receives differs depending upon a position or posture of the RFID tag, and hence the power, of which the magnitude is optimum in order for all of the RFID tags to work, is not always obtained.

The present invention has been accomplished in consideration of the above-mentioned problems, and an object thereof is to provide a technology capable of enhancing the detection precision of the RFID tag.

Further, another object of the present invention is to provide a technology capable of eliminating influences of the position and the posture of the RFID tag, and surely producing the power supply condition optimum for the RFID tag at least once.

### Means For Solving the Problems

The 1st invention for solving the above-mentioned task, which is an RFID system, characterized in being configured so that each of a role of an antenna for transmitting an interrogation wave and a role of an antenna for transmitting a power supply wave can be replaced with the other. P The 2nd invention for solving the above-mentioned problem, in the above-mentioned 1st invention, is characterized in being configured to transmit the interrogation wave and the power supply wave while changing a magnitude of a power of at least one of them.

The 3rd invention for solving the above-mentioned task, which is an RFID system, said RFID system comprising at least two transmitting means for transmitting one of an interrogation wave and a power supply wave to an RFID tag, characterized in being configured so that at least one interrogation wave and at least one power supply wave are transmitted to the RFID tag by employing said two transmitting means or more, and the waves, which said transmitting means transmit, are mutually switched at a predetermined timing.

The 4th invention for solving the above-mentioned problem, in the above-mentioned 3rd invention, is characterized in that said transmitting means, which comprises a power adjusting means for adjusting an output power of one of the interrogation wave and the power supply wave, is configured to transmit the interrogation wave and the power supply wave while changing a magnitude of a power of one of them.

The 5th invention for solving the above-mentioned task, which is an RFID system, characterized in comprising: at least two readers for transmitting one of an interrogation wave and a power supply wave to an RFID tag; and a controlling means for taking a control in such a manner that controlling said readers allows at least one interrogation wave and at least one power supply wave to be transmitted to the RFID tag, and the waves, which said readers transmit, to be mutually switched at a predetermined timing.

The 6th invention for solving the above-mentioned problem, in the above-mentioned 1st invention, is characterized in that: said reader comprises a power adjusting means for adjusting an output power of one of the interrogation wave and the power supply wave; and said controlling means controls said power adjusting means so that the interrogation wave and the power supply wave are transmitted while a magnitude of a power of one of them is changed.

The 7th invention for solving the above-mentioned task, which is a reader in an RFID system, characterized in comprising a transmitting means for transmitting one of an interrogation wave and a power supply wave to an RFID tag based upon a switchover control.

The 8th invention for solving the above-mentioned problem, in the above-mentioned 1st invention, comprising a power adjusting means for adjusting an output power of one of the interrogation wave and the power supply wave, characterized in being configured to transmit the interrogation wave and the power supply wave while changing a magnitude of a power of one of them.

The 9th invention for solving the above-mentioned task, which is a control program of an RFID system, characterized in causing an information processing device to execute; a process of causing at least two transmitting means, each of which transmits one of an interrogation wave and a power supply wave to an RFID tag, to transmit at least one interrogation wave and at least one power supply wave; and a process of switching the waves, which said transmitting means transmit, at a predetermined timing.

The 10th invention for solving the above-mentioned problem, in the above-mentioned 9th invention, is characterized in causing the information processing device to execute a process of causing said transmitting means to transmit said interrogation wave and said power supply wave while changing a magnitude of a power of one of them.

The 11th invention for solving the above-mentioned task, which is a transmission method of transmitting an interrogation wave and a power supply wave to an RFID tag, characterized in replacing each of a role of an antenna for transmitting the interrogation wave and a role of an antenna for transmitting the power supply wave with other, thereby to transmit the interrogation wave and the power supply wave.

The 12th invention for solving the above-mentioned problem, in the above-mentioned 11th invention, is characterized in transmitting the interrogation wave and the power supply wave while changing a magnitude of a power of at least one of them.

The present invention is characterized in being configured so that a read operation and a supply operation are assigned to a plurality of the antennas, which are simultaneously utilized, and yet each of their roles is replaced with the other. Making a configuration in such a manner makes it possible to eliminate influences of the position and the posture of the RFID tag, and to surely produce the power supply condition optimum for each RFID tag at least once.

In addition hereto, transmitting the interrogation wave and the power supply wave while changing the magnitude of the power of at least one of them makes it possible to obtain a higher detection precision.

### Effect of the Invention

The present invention can provide the RFID system capable of enhancing the detection precision of the RFID tag. The reason is that assigning a read operation and a supply operation to a plurality of the antennas, which are simultaneously utilized, and yet replacing each of their roles with the other makes it possible to eliminate influences of the position and the posture of the RFID tag, and to surely produce the power supply condition optimum for each RFID tag at least once.

Further, the present invention enables a higher detection precision to be obtained by transmitting the interrogation wave and the power supply wave while changing the magnitude of the power of at least one of them.

### BRIEF DESCRIPTION OF THE DRAWINGS

FIG. 1 is a view illustrating an example of a general configuration of the RFID system.

FIG. 2 is an appearance view of the RFID system in a first embodiment.

FIG. 3 is a block diagram of the RFID system in the first embodiment.

FIG. 4 is a view for explaining an operation of the first embodiment of the present invention.

FIG. 5 is a view for explaining a flow of the process of the first embodiment of the present invention.

FIG. 6 is a block diagram of another embodiment in the first embodiment.

FIG. 7 is a block diagram of the RFID system in a second embodiment.

FIG. 8 is a view for explaining an operation of the second embodiment of the present invention.

FIG. 9 is a view for explaining an operation of the second embodiment of the present invention.

FIG. 10 is a view for explaining an operation of the second embodiment of the present invention.

FIG. 11 is a view for explaining an operation of the second embodiment of the present invention.

FIG. 12 is a block diagram of a third embodiment.

FIG. 13 is a view for explaining an operation of the third embodiment of the present invention.

FIG. 14 is a view illustrating a configuration of an experimental system for measuring an effect of an improvement to the detection precision by the present invention in the case of reading off a plurality of RFID tags 200 fixed to a plastic-made tray by employing a reader 100-1 and a reader 100-2.

FIG. 15 is a graph illustrating a measurement result of the experimental system of FIG. 14.

### DESCRIPTION OF NUMERALS

100-1 and 100-2 readers

101 controlling means

102-1 and 102-2 antennas

103-1 and 103-2 power adjusting means

104-1 and 104-2 modulating/demodulating means

105-1 and 105-2 encoding/decoding means

200 RFID tag

300 external device

### BEST MODE FOR CARRYING OUT THE INVENTION

Next, the best mode for carrying out the present invention will be explained in details by making a reference to the accompanied drawings.

### First Embodiment

A first embodiment will be explained.

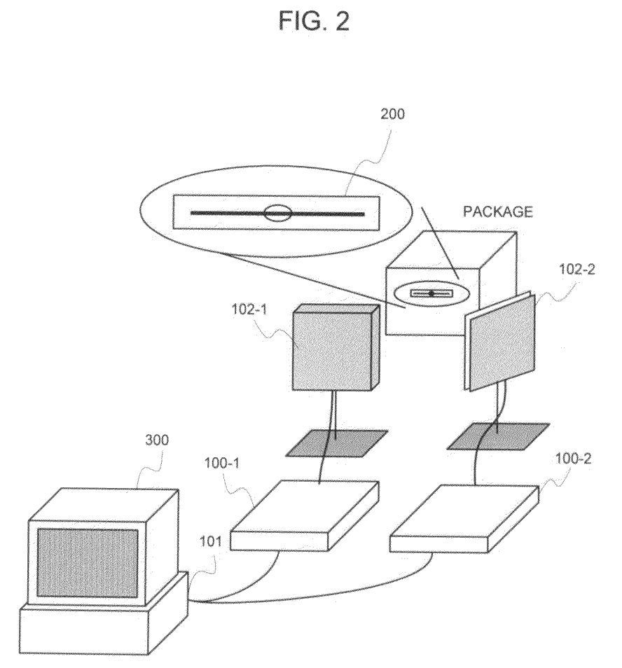

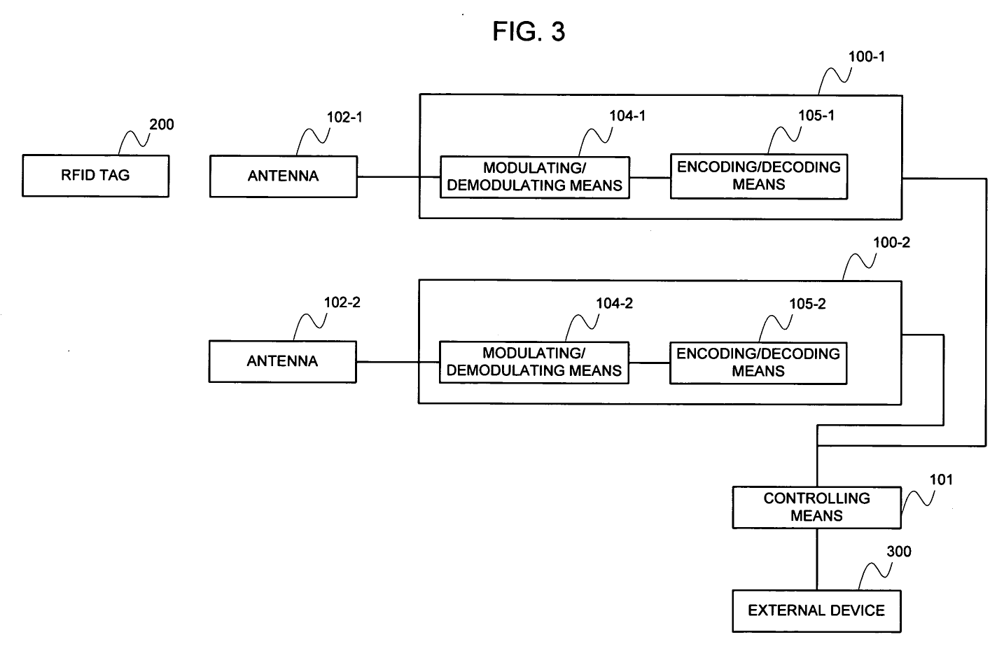

FIG. 2 is an appearance view of the RFID system in the first embodiment, and FIG. 3 is a block diagram of the RFID system in the first embodiment.

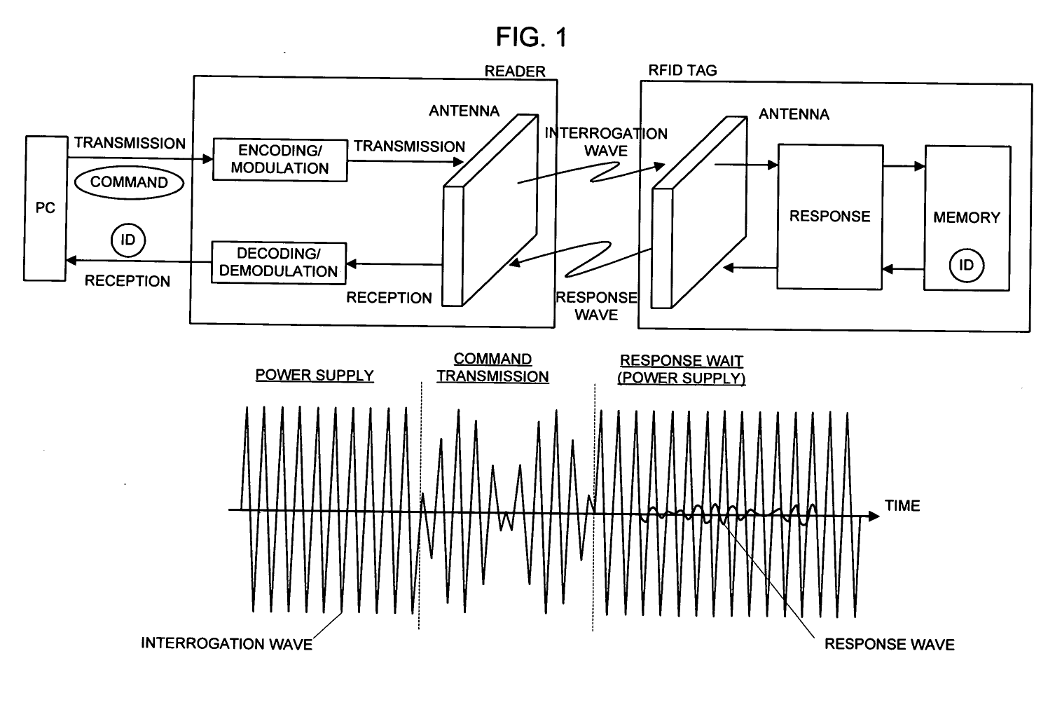

The RFID system in the first embodiment, as shown in FIG. 1, is configured of an RFID tag 200 for holding an ID attached to a package etc., receiving an interrogation wave or a power supply wave from antennas 102-1 and 102-2, and transmitting an ID filed inside it as a response wave, a controlling means 101 for controlling an operation of each section of readers 100-1 and 100-2, an external device 300 for giving an instruction to the controlling means 101, the reader 100-1 and 100-2 for transmitting the interrogation wave or the power supply wave to the RFID tag 200, or reading off a response wave from the RFID tag 200 through the antennas 102-1 and 102-2, respectively, the antennas 102-1 and 102-2 for transmitting the interrogation wave or the power supply wave from the readers 100-1 and 100-2, or receiving the response wave from the RFID tag 200, respectively. Additionally, in the present invention, the so-called interrogation wave signifies a wave that is configured of a carrier wave for playing a role of supplying a power source to the RFID tag, and a modulated portion of a command to the RFID tag, and the so-called power supply wave signifies a carrier wave for playing a role of supplying the power resource to the RFID tag.

The readers 100-1 and 100-2, as shown in FIG. 3, are configured of encoding/decoding means 105-1 and 105-2 for generating a code, which is transmitted to the RFID tag 200, to convey it to modulating/demodulating means 104-1 and 104-2, and yet picking up data from the demodulated signal, which is output from the modulating/demodulating means 104-1 and 104-2, respectively, and the modulating/demodulating means 104-1 and 104-2 for, based upon the instruction by the controlling means 101, modulating the encoded signal from the encoding/decoding means 105-1 and 105-2, or generating the power supply wave to convey it to the antennas 102-1 and 102-2, and yet demodulating the response wave from the RFID tag 200, which is output from the antennas 102-1 and 102-2, to transmit it to the encoding/decoding means 105-1 and 105-2, respectively.

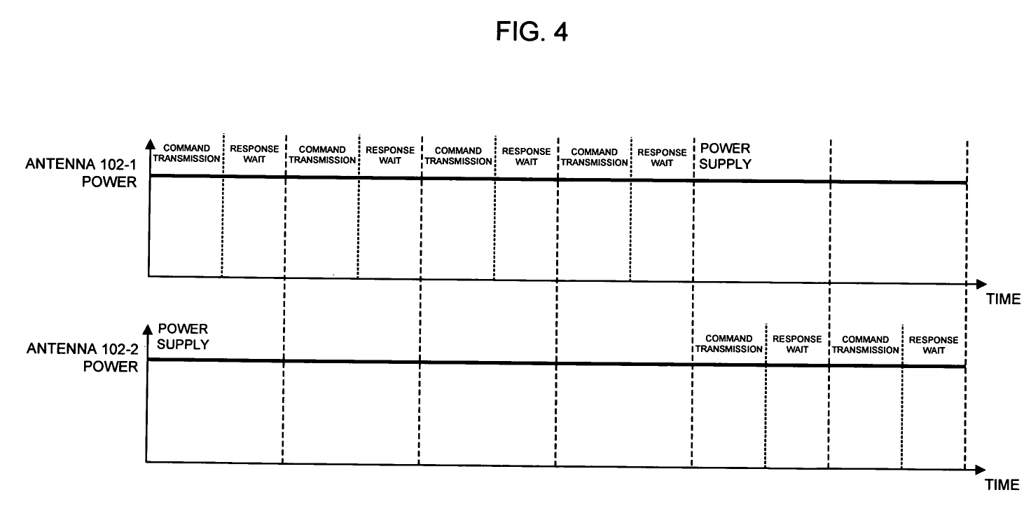

FIG. 4 is a view for explaining an operation of the first embodiment of the present invention.

In FIG. 4, the magnitude of the power and the operational timing of the interrogation wave or the power supply wave being transmitted from the antenna 102-1 are illustrated in the upper stage, and the magnitude of the power and the operational timing of the interrogation wave or the power supply wave being transmitted from the antenna 102-2 in the lower stage, respectively.

As shown in FIG. 4, the first embodiment of the present invention is characterized in that the antennas 102-1 and 102-2 executes a read operation of transmitting the interrogation wave and receiving the response wave, and a power supply operation of transmitting the power supply wave while replacing each of these operations with the other, respectively.

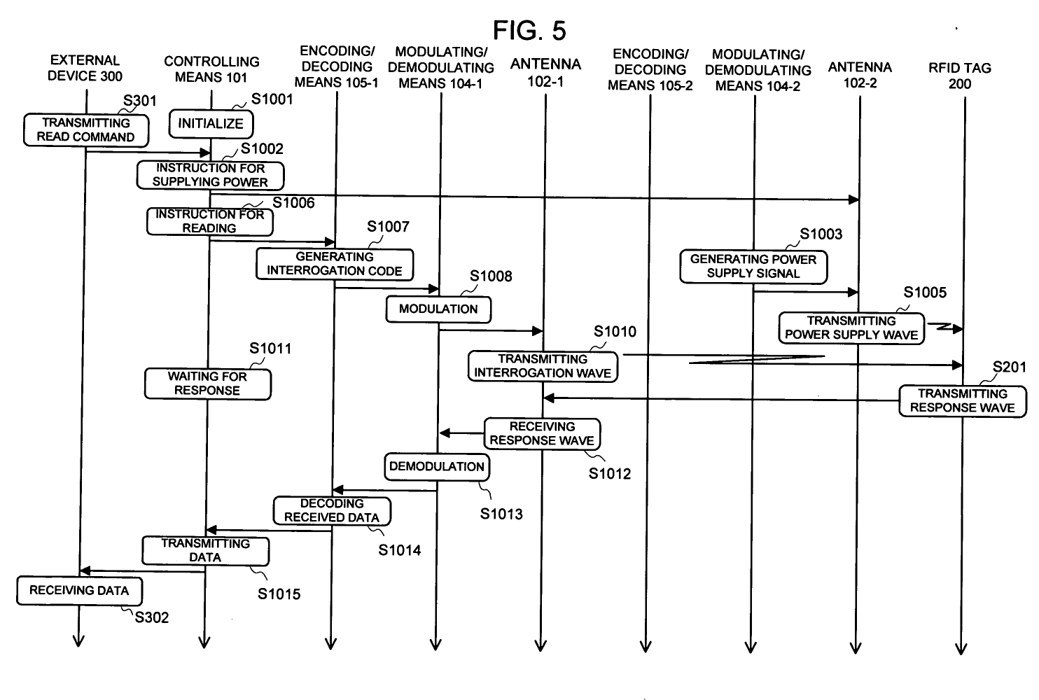

Next, a flow of the process of the first embodiment of the present invention will be explained by employing FIG. 5.

At first, after the controlling means 101 initializes the entirety of the reader 100 (S1001), it waits for a command from the external device 300.

And, when the command is transmitted from the external deice 300 (S301), the controlling means 101 firstly sends an instruction to the reader 100-2 so that it generates a power supply wave (S1002). Upon receipt of the instruction, the modulating/demodulating means 104-2 generates a power supply signal (S1003), and transmits the power supply wave with a predetermined power to the RFID tag 200 through the antenna 102-2 (S1005). Herein, the so-called power supply wave is a carrier wave similar to the power supply portion of the interrogation wave in the bottom of FIG. 1 that is successively transmitted.

Further, the controlling means 101 simultaneously sends an instruction to each section so that it generates the interrogation wave to the RFID tag (S1006).

After the encoding/decoding means 105-1 generates a code for a command, which is forwarded to the RFID tag, upon receipt of the instruction (S1007), and generates an interrogation wave by applying the modulation necessary for transmission, which is carried out by the modulating/demodulating means 104-1, hereto (S1008), it transmits the interrogation wave with a predetermined power through the antenna 102-1 (S1010).

The controlling means 101 comes into a situation of waiting for a response wave from the RFID tag (S1011).

The RFID tag 200 receives the interrogation wave and transmits the ID filed inside the RFID tag 200 as a response wave responding to the superposed code for a command (S201).

Upon receipt of the response wave from the antenna 102-1 (S1012), the reader 100-1 executes each of the demodulating process by the modulating/demodulating means 104-1, and the decoding process by the encoding/decoding means 105-1 (S1013 and S1014), picks up the ID, which is included in the response wave, as data, and transmits it to the external device 300 (S1015).

The external device 300 executes a displaying process, a computing process, etc. based upon the data received from the reader 100-1 (S302).

The controlling means 101 repeats a series of these processes predetermined number of times (for example, four times in an example shown in FIG. 4), and thereafter, gives the readers 100-1 and 101-2 an instruction for replacing each of the role of transmitting the interrogation wave and the role of transmitting the power supply wave with the other. That is, the controlling means 101 gives the reader 100-1 an instruction for making a switchover from the transmission of the interrogation wave to the transmission of the power supply wave, and gives the reader 100-2 an instruction for making a switchover from the transmission of the power supply wave to the transmission of the interrogation wave.

Next, an effect of the embodiment of the present invention will be explained.

The first embodiment of the present invention, as shown in FIG. 3, is characterized in being configured so that a read operation and a supply operation are assigned to a plurality of the antennas, which are simultaneously utilized, and yet each of their roles is replaced with other. By making configuration in such a manner, detection results obtained by replacing the role of each antenna in each read operation are integrated, thereby enabling a higher detection precision to be obtained as a whole.

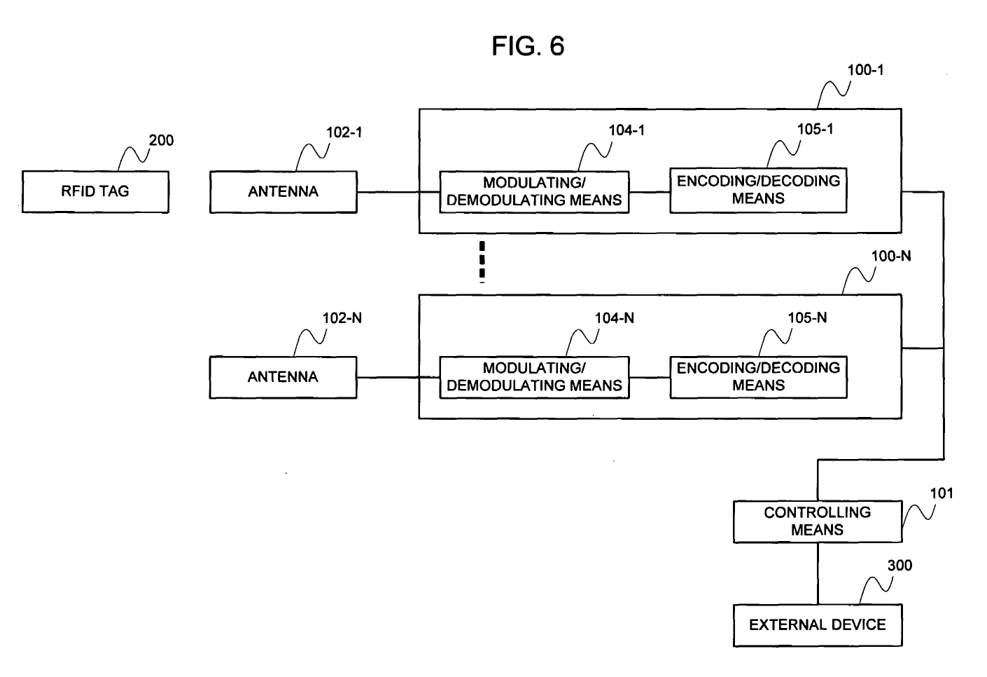

Additionally, in the foregoing embodiment, by means of two readers 100-1 and 100-2, the interrogation wave and the power supply wave were transmitted while they were switched; however, the present invention is not limited hereto, and for example, as shown in FIG. 6, it is also possible to employ the reader in plural. In a case of employing a plurality of the readers in such a manner, the controlling means 101 is adapted to take a control so that at least one reader transmits the interrogation wave. Further, the timing of the switchover, at which all readers simultaneously switch the wave being transmitted, is not necessitated, and a configuration may be made so that the waves being transmitted are switched while the timing is shifted.

### Second Embodiment

A second embodiment of the present invention will be explained in details by making a reference to the accompanied drawings.

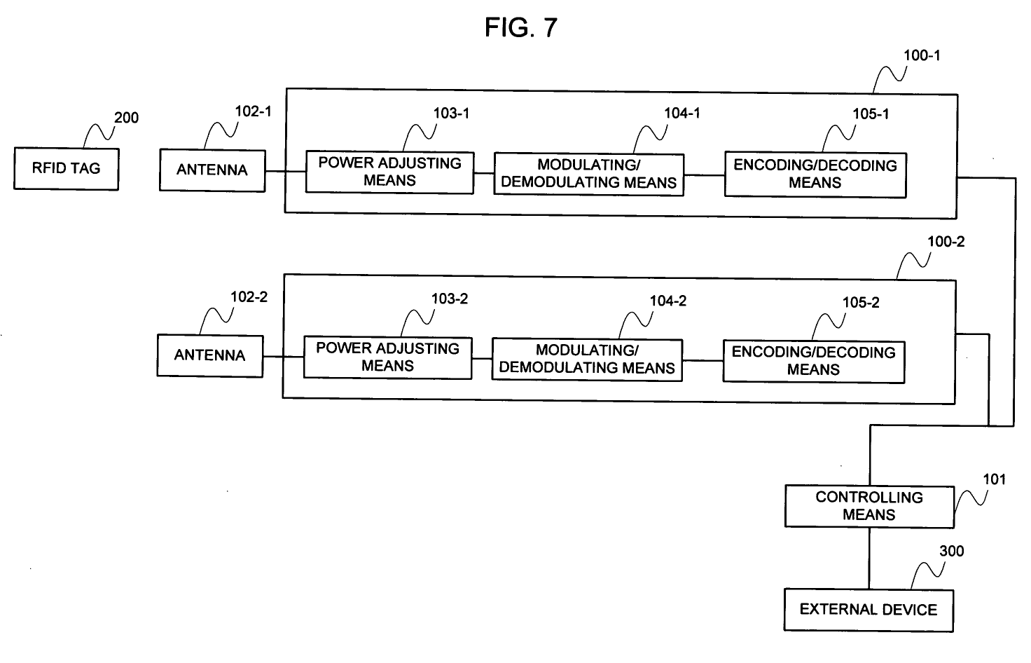

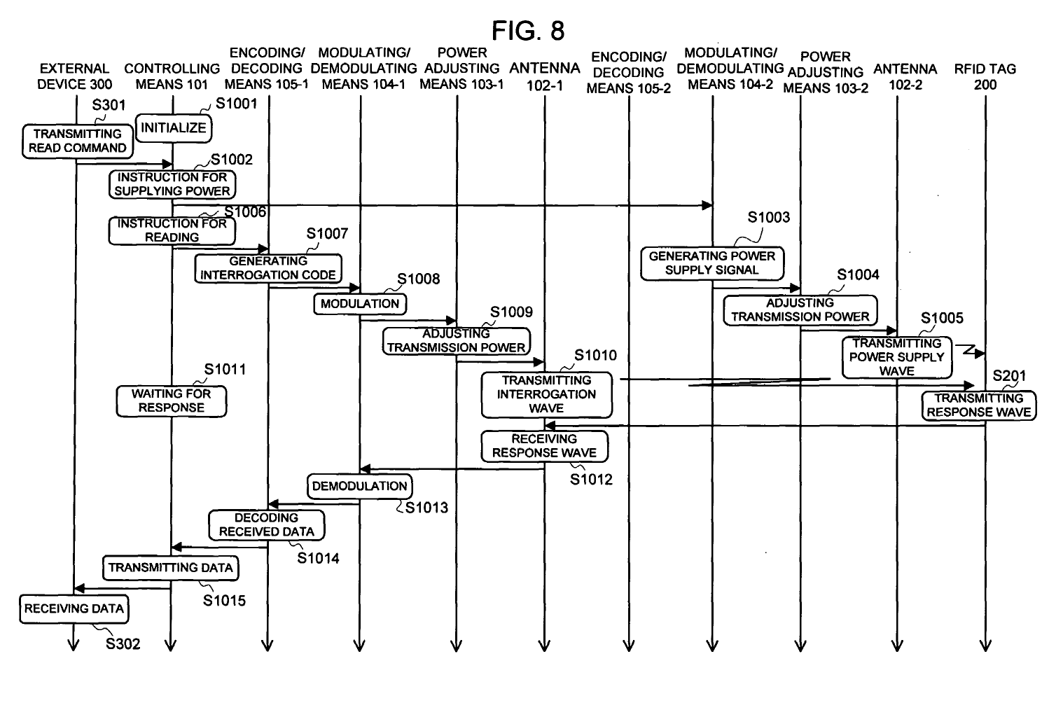

Upon making a reference to FIG. 7 and FIG. 8, the second embodiment of the present invention, as compared with the first embodiment, is characterized in: including a power adjusting means 103-1 for adjusting an output power of the interrogation wave generated by the modulating/demodulating means 104-1, and a power adjusting means 103-2 for adjusting an output power of the interrogation wave generated by the modulating/demodulating means 104-2; and that the antenna 102-1 is configured to transmit the modulated output of the power adjusting means 103-1 as an interrogation wave (S1009), and the antenna 102-2 is configured to transmit the modulated output of the power adjusting means 103-2 as an interrogation wave (S1004).

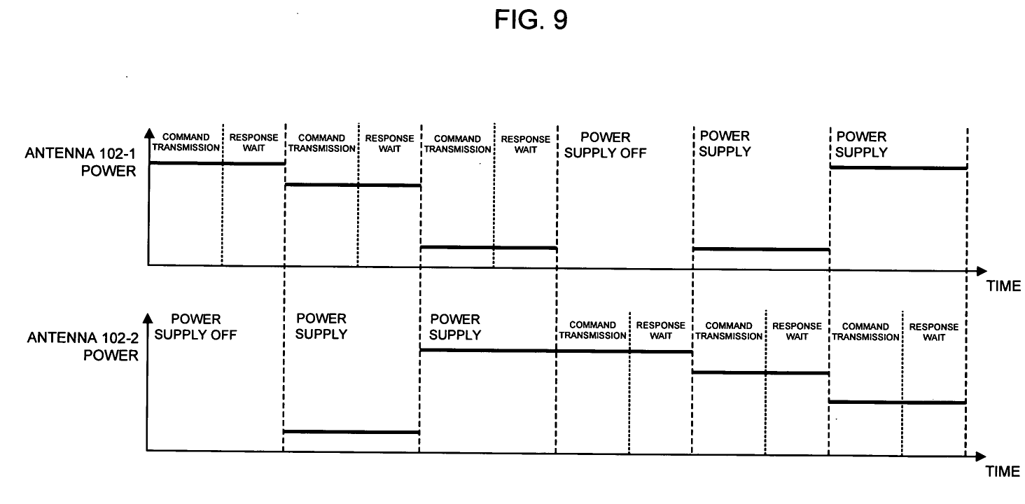

FIG. 9 is a view for explaining an operation of the second embodiment of the present invention.

In FIG. 9, the magnitude of the power and the operational timing of the interrogation wave or the power supply wave being transmitted from the antenna 102-1 are illustrated in the upper stage, and the magnitude of the power and the operational timing of the interrogation wave or the power supply wave being transmitted from the antenna 102-2 in the lower stage, respectively.

As shown in FIG. 9, in the second embodiment of the present invention, at the moment that each of the antennas 102-1 and 102-2 executes a read operation of transmitting the interrogation wave and receiving the response wave, and a power supply operation of transmitting the power supply wave while replacing each of these operation with the other, it execute the operation while changing the magnitudes of the powers of the interrogation wave and the power supply wave.

Additionally, the adjustment of the power is not limited to the adjustment of both powers of the interrogation wave and the power supply wave, which is shown in the foregoing example, and a configuration may be made so that, for example, only one of the powers of the interrogation wave and the power supply wave is adjusted.

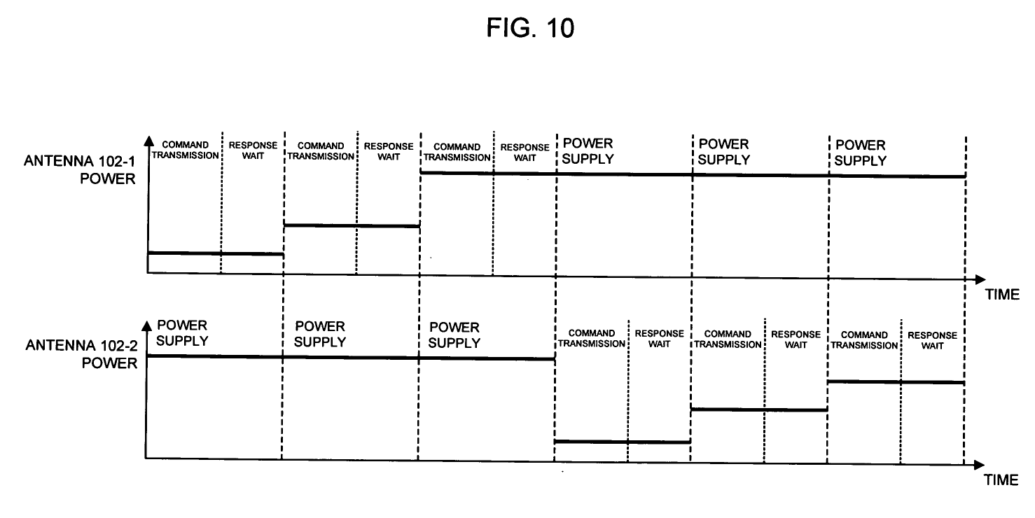

A specific example in the case of adjusting only the power of the interrogation wave is shown in FIG. 10. In FIG. 10, the interrogation wave being transmitted from the antenna 102-1 and the interrogation wave being transmitted from the antenna 102-2 are transmitted while their powers are adjusted, whereas the power supply wave is transmitted with the power kept at a constant level. That is, the reader 100-1 and the reader 100-2 transmit the interrogation wave of which the power has been adjusted by the power adjusting means 103-1 and 103-2, respectively, only in a case of transmitting the interrogation wave, and transmit the power supply wave with the power kept at a constant level in a case of transmitting the power supply wave.

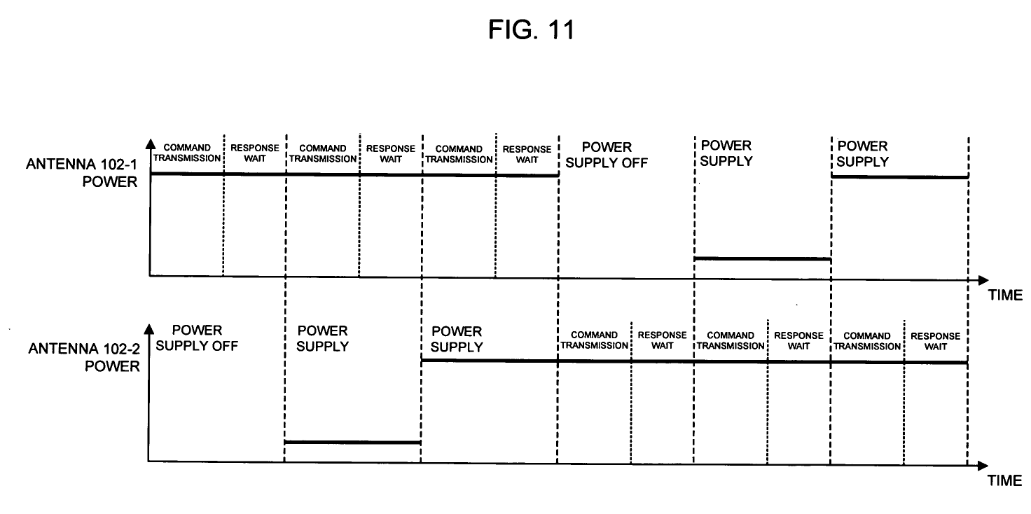

Further, a specific example in the case of adjusting only the power of the power supply wave is shown in FIG. 11. In FIG. 11, the power supply wave being transmitted from the antenna 102-1 and the power supply wave being transmitted from the antenna 102-2 are transmitted while their powers are adjusted, whereas the interrogation wave is transmitted with the power kept at a constant level. That is, the reader 100-1 and the reader 100-2 transmit the power supply wave of which the power has been adjusted by the power adjusting means 103-1 and 103-2, respectively, only in a case of transmitting the power supply wave, and transmit the interrogation wave with the power kept at a constant level in a case of transmitting the interrogation wave.

The portion other than the foregoing is similar to that of the first embodiment of the present invention, so its explanation is omitted.

Next, an effect of the embodiment of the present invention will be explained.

The second embodiment of the present invention, as compared with the first embodiment, is characterized in that periodically changing the powers of the interrogation wave and the power supply wave makes it possible to eliminate influences of the position and the posture of the RFID tag, and to surely produce the power supply condition optimum for each RFID tag at least once.

Additionally, needless to say, a step number, a period, and a change pattern of the power of each of the interrogation wave and the power supply wave should be set responding to the reader being utilized, and the surrounding environment.

### Third Embodiment

A third embodiment of the present invention will be explained in details by making a reference to the accompanied drawings.

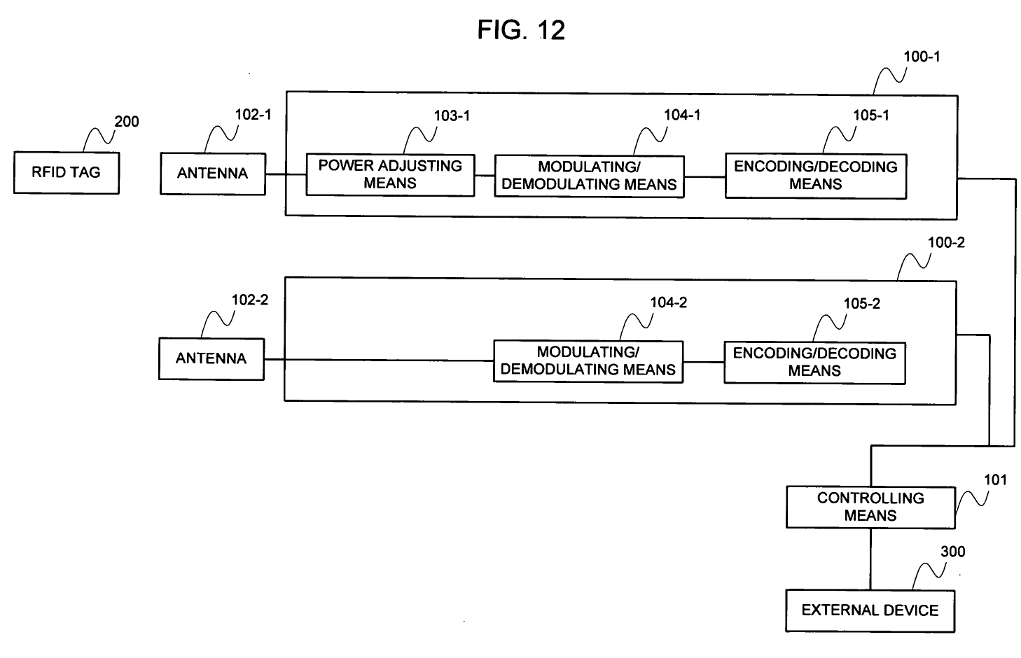

FIG. 12 is a block diagram of the third embodiment. In the second embodiment, a configuration was made so that the reader 100-1 and the reader 100-2 included the power adjusting means 103-1 and 103-2, respectively, and each of them transmitted the interrogation wave or the power supply wave after adjusting the power; however, in the third embodiment, as shown in FIG. 12, a configuration is made so that only reader 100-1 includes the power adjusting means 103-1, and transmits the interrogation wave or the power supply wave after adjusting the power.

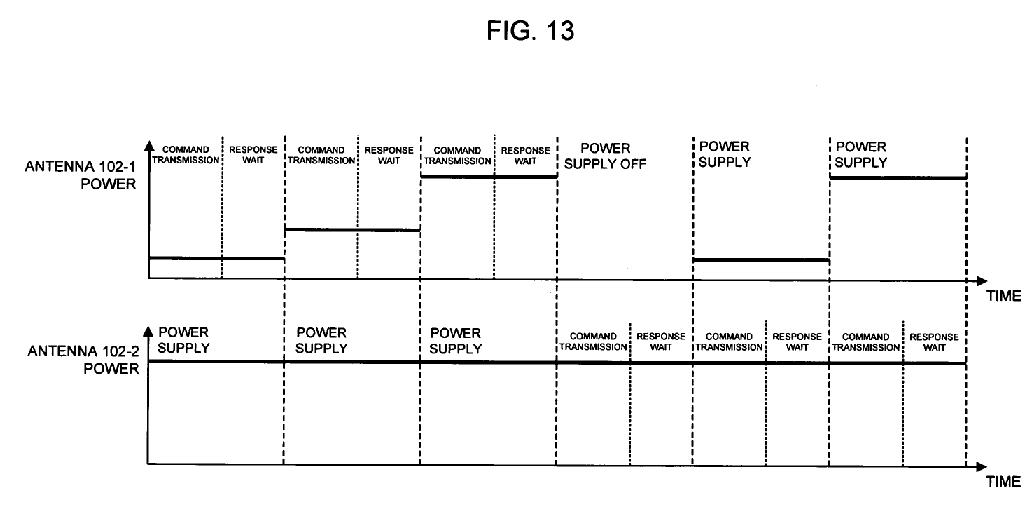

FIG. 13 is a view for explaining an operation of the third embodiment of the present invention.

In FIG. 13, the magnitude of the power and the operational timing of the interrogation wave or the power supply wave being transmitted from the antenna 102-1 are illustrated in the upper stage, and the magnitude of the power and the operational timing of the interrogation wave or the power supply wave being transmitted from the antenna 102-2 in the lower stage, respectively.

As shown in FIG. 13, in the third embodiment of the present invention, at the moment that each of the antennas 102-1 and 102-2 executes a read operation of transmitting the interrogation wave and receiving the response wave, and a power supply operation of transmitting the power supply wave while replacing each of these operations with the other, the interrogation wave and the power supply wave are transmitted from the antenna 102-1 while their magnitudes of the powers are changed, and the interrogation wave and the power supply wave each having a constant power are transmitted from the antenna 102-2.

Even in such a configuration, an effect similar to that of the foregoing embodiment is obtained.

Additionally, similarly to the foregoing embodiment, needless to say, a step number, a period, and a change pattern of the power of each of the interrogation wave and 5 the power supply wave should be set responding to the reader being utilized, and the surrounding environment.

### EXAMPLE 1

The example 1 is an experimental example in the case of reading off a plurality of the RFID tags 200 fixed to a plastic-made tray by employing the reader 100-1 and the reader 100-2 in the foregoing first embodiment.

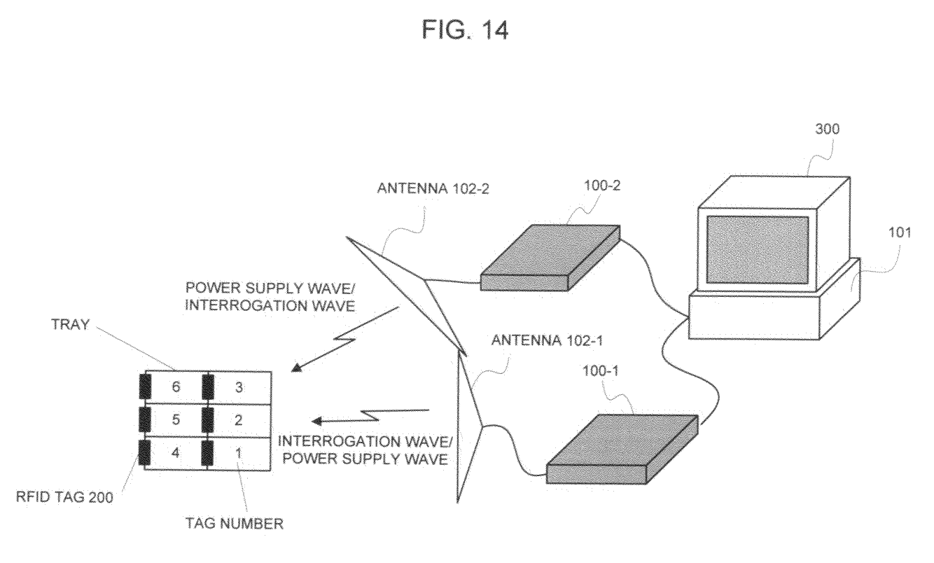

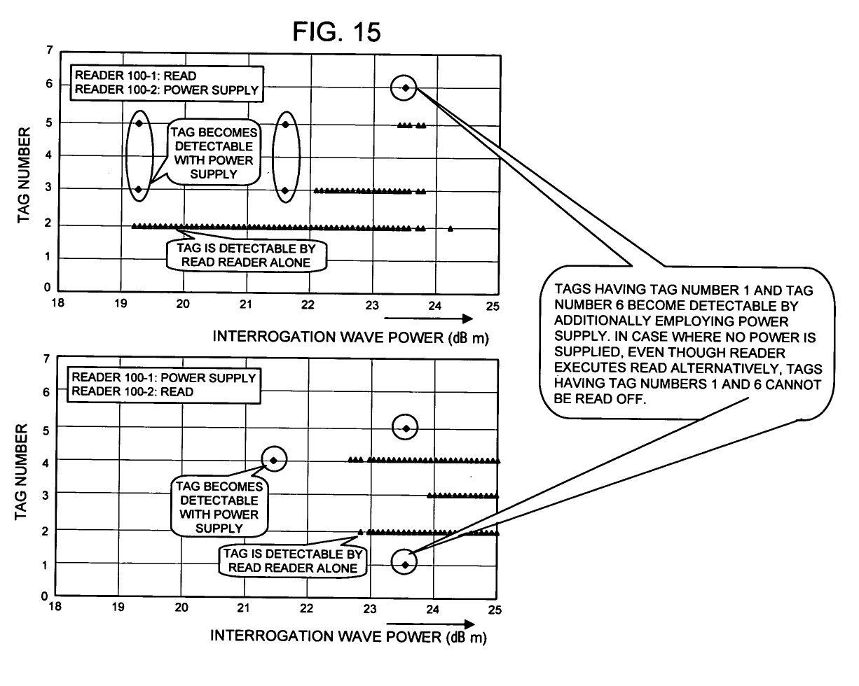

FIG. 14 is a view illustrating a configuration of an experimental system for measuring an effect of an improvement to the detection precision by the present invention in the case of reading off a plurality of the RFID tags 200 fixed to a plastic-made tray by employing the reader 100-1 and the reader 100-2, and FIG. 15 is a graph illustrating its measurement result.

In the experimental system of FIG. 14, in the graphs of the upper stage/lower stage of FIG. 15, the power of the interrogation wave being output from the reader playing the role of the reading is illustrated in the traverse axis, and the tag number in the longitudinal axis, respectively. A triangular point indicates that the tag is detectable by the reader alone playing the role of the reading, and a lozenged point indicates that the tag becomes detectable with the additional power supply. In FIG. 15, the upper stage illustrates an experimental result in the case of having adopted the reader 100-1 as a reader playing the role of the reading, and the reader 100-2 as a reader playing the role of the power supply, and further, the lower stage illustrates an experimental result in the case of having adopted the reader 100-1 as a reader playing the role of the power supply, and the reader 100-2 as a reader playing the role of the reading. The covering range of the interrogation wave and the power supply wave are common in any experiment.

The graph in the upper stage of FIG. 15 indicates that the tag having the tag number 6, which is undetectable by the reader 100-1 alone, becomes detectable by additionally adopting the reader 100-2 as a reader playing the role of the power supply. Likewise, the graph in the lower stage of FIG. 15 indicates that the tags having the tag number 1 and the tag number 5, which are undetectable by the reader 100-2 alone, becomes detectable by additionally adopting the reader 100-1 as a reader playing the role of the power supply. In particular, the tags having the tag number 1 and the tag number 6, which cannot be detected by utilizing only one of the reader 100-1 and the reader 100-2, becomes detectable only by additionally adopting the reader playing the role of the power supply. This indicates that only combining the results obtained by simply utilizing the reader does not always lead to an improvement to the detection precision in some cases, and that adopting both of the reader playing the role of the reading and the reader playing the role of the power supply, and yet replacing each of their roles with the other, which is the case with the present invention, make it possible to enhance the detection precision as a whole of the RFID system.

1. An RFID system, comprising:
means for replacing each of a role of an antenna for transmitting an interrogation wave and a role of an antenna for transmitting a power supply wave with the other.

2. The RFID system according to claim 1, further comprising means for transmitting the interrogation wave and the power supply wave while changing a magnitude of a power of at least one of them.

3. An RFID system, said RFID system comprising:
at least two transmitting means for transmitting one of an interrogation wave and a power supply wave to an RFID tag, wherein at least one interrogation wave and at least one power supply wave are transmitted to the RFID tag by employing said two transmitting means or more, and the waves, which said transmitting means transmit, are mutually switched at a predetermined timing.

4. The RFID system according to claim 3, wherein said transmitting means, which comprises a power adjusting means for adjusting an output power of one of the interrogation wave and the power supply wave, is configured to transmit the interrogation wave and the power supply wave while changing a magnitude of a power of one of them.

5. An RFID system, comprising:
at least two readers for transmitting one of an interrogation wave and a power supply wave to an RFID tag; and
a controlling means for taking a control in such a manner that controlling said readers allows at least one interrogation wave and at least one power supply wave to be transmitted to the RFID tag, and the waves, which said readers transmit, to be mutually switched at a predetermined timing.

6. The RFID system according to claim 5, wherein:
said reader comprises a power adjusting means for adjusting an output power of one of the interrogation wave and the power supply wave; and
said controlling means controls said power adjusting means so that the interrogation wave and the power supply wave are transmitted while a magnitude of a power of one of them is changed.

7. A reader in an RFID system, comprising:
a transmitting means for transmitting one of an interrogation wave and a power supply wave to an RFID tag based upon a switchover control.

8. The reader according to claim 7, further comprising:
a power adjusting means for adjusting an output power of one of the interrogation wave and the power supply wave wherein said transmitting means transmits the interrogation wave and the power supply wave while changing a magnitude of a power of one of them.

9. A computer readable medium storing a control program of an RFID system, wherein, when executed by an i.p.d., causing the information processing device to perform the steps of:
causing at least two transmitting means, each of which transmits one of an interrogation wave and a power supply wave to an RFID tag, to transmit at least one interrogation wave and at least one power supply wave; and
switching the waves, which said transmitting means transmit, at a predetermined timing.

10. The computer readable medium according to claim 9, further causing the information processing device to perform a step of causing said transmitting means to transmit said interrogation wave and said power supply wave while changing a magnitude of a power of one of them.

11. A transmission method of transmitting an interrogation wave and a power supply wave to an RFID tag, comprising:
replacing each of a role of an antenna for transmitting the interrogation wave and a role of an antenna for transmitting the power supply wave with other, thereby to transmit the interrogation wave and the power supply wave.

12. The transmission method according to claim 11, further comprising:
transmitting the interrogation wave and the power supply wave while changing a magnitude of a power of at least one of them.
